(19) United States
(12) Patent Application Publication
(10) Pub. No.: US 2013/0055234 A1
(43) Pub. Date: Feb. 28, 2013

(54) MEDIA MANAGER UPGRADING

(71) Applicants: Sunil Limbasia, Irving, TX (US); Aravind Perumandla, Irving, TX (US); John Christudass, Coppell, TX (US); Abhilash Paul, Irving, TX (US); Ravi Penumatsa, Addison, TX (US)

(72) Inventors: Sunil Limbasia, Irving, TX (US); Aravind Perumandla, Irving, TX (US); John Christudass, Coppell, TX (US); Abhilash Paul, Irving, TX (US); Ravi Penumatsa, Addison, TX (US)

(73) Assignee: VERIZON PATENT AND LICENSING INC., Basking Ridge, NJ (US)

(21) Appl. No.: 13/220,882

(22) Filed: Aug. 30, 2011

(51) Int. Cl. G06F 9/44

(52) U.S. Cl. 717/173

(57) ABSTRACT

A device may execute a media manager application for managing media content stored by the device and download a media manager application upgrade using a background download operation that is independent from execution of the media manager application. The device may cache the media manager application upgrade in a cache memory and notify a user of the device that the media manager application upgrade is ready for installation. The device may receive an install command, corresponding to the media manager application upgrade, from the user and install the media manager application upgrade in response to the install command.

### BACKGROUND

Currently available network technologies include software programs that enable consumers to browse, purchase, and download books, music, movies, and other forms of media over the Internet. However, such software programs frequently include one or more of a variety of deficiencies. For example, such software programs often must be updated via processes that require a significant amount of user interaction or take a long time to download and install.

### BRIEF DESCRIPTION OF THE DRAWINGS

FIG. 1 is a diagram of an example overview of an implementation described herein;

FIG. 2 is a diagram of an example environment in which systems and/or methods, described herein, may be implemented;

FIG. 3 is a diagram of example components of a device of FIG. 2;

FIG. 4 is a diagram of example functional components of a user device according to one or more implementations described herein;

FIG. 5 is a diagram of an example process for upgrading a media manager application according to one or more implementations described herein;

FIG. 6 is a diagram of an example process for installing a media manager application upgrade according to one or more implementations described herein; and

FIGS. 7A-7B are diagrams of example processes and data structures according to one or more implementations described herein.

### DETAILED DESCRIPTION OF PREFERRED EMBODIMENTS

The following detailed description refers to the accompanying drawings. The same labels and/or reference numbers in different drawings may identify the same or similar elements.

In one or more implementations, described herein, devices may be used to upgrade a media manager application in a manner that is expeditious and that requires a minimal amount of user interaction. For example, a user device may execute a media manager application for managing locally stored media files (e.g., audio files, video files, text files, etc.). The user device may detect that a media manager application upgrade is available from an upgrade server and download the media manager application upgrade using a background download operation that does not disturb the execution of the media manager application. The user device may cache the media manager application upgrade as temporary data, notify a user of the user device that a media manager application upgrade is available for installation, and install the media manager application upgrade in response to receiving an install command from the user.

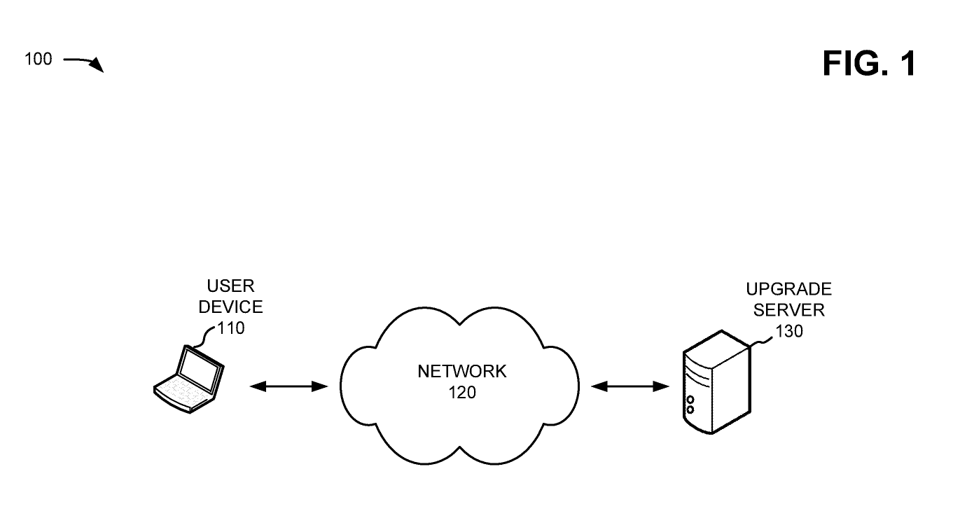

FIG. 1 is a diagram of an example overview 100 of an implementation described herein. As depicted, overview 100 may include user device 110, network 120, and upgrade server 130. In some implementations, one or more of the systems and/or devices of FIG. 1 may correspond to one or more systems or devices discussed elsewhere in this specification.

User device 110 may include one or more of a variety of computing devices. For example, user device 110 may include a smart phone, a laptop computer, a tablet computer, a desktop computer, or one or more other types of computing or communication devices. User device 110 may include a media manager application for managing media files stored by user device 110 and/or browsing, purchasing, and/or downloading additional media files. In some implementations, the media manager application may enable a user to stream media files stored by user device 110 to one or more other devices (not shown in FIG. 1), including other user devices 110, set-top-boxes (STBs), and/or one or more other types of electronic devices.

Network 120 may include any type of network or combination of networks. For example, network 120 may include a local area network (LAN) (e.g., an Ethernet network), a wireless LAN (WLAN) (e.g., an IEEE 802.11x network), a wide area network (WAN) (e.g., the Internet), and/or a wireless WAN (WWAN) (e.g., a Long-Term Evolution (LTE) network, a High-Speed Packet Access (HSPA) network, an Evolved High Rate Packet Data (eHRPD) network, etc.). Network 120 may also, or alternatively, include an Internet Protocol (IP) multimedia subsystem (IMS) network, a fiber optic (e.g., a fiber optic service (FiOS)) network, a voice over IP (VoIP) network, a metropolitan area network (MAN), an ad hoc network, a virtual network (e.g., a virtual private network (VPN)), and/or a telephone network (e.g., a Public Switched Telephone Network (PSTN)).

Upgrade server 130 may include one or more of a variety of computing devices. For example, upgrade server 130 may include a server, a cluster of servers, or one or more other types of computing or communication devices. In implementations where upgrade service 130 includes multiple devices, the devices may be located in a single geographic location or multiple geographic locations. Upgrade server 130 may include one or more media manager application upgrades and/or updates, which may include one or more data files (e.g., program files, executable files, configuration files, directory files, compressed files, catalog files, media files, etc.), defining or otherwise corresponding to the operation and/or structure of a media manager application. In some implementations, a media manager application upgrade may include a particular version (e.g., the most recently released version) of a media manager application.

As mentioned above, user device 110 may execute a media manager application. At some point, user device 110 may determine that a media manager application upgrade is available from upgrade server 130, and user device 110 may download the media manager application upgrade. In some implementations, user device 110 may download the media manager application upgrade using a background download operation that does not disturb the execution of the media manager application (e.g., a user may continue browsing, purchasing, and downloading media files while the media manager application upgrade is being downloaded). Additionally, or alternatively, the media manager application upgrade may be cached as temporary data. At some point after the media manager application upgrade is downloaded, a user may be notified that the media manager application upgrade is ready for installation, and user device 110 may install the media manager application upgrade in response to receiving an install command, corresponding to the media manager application upgrade, from the user.

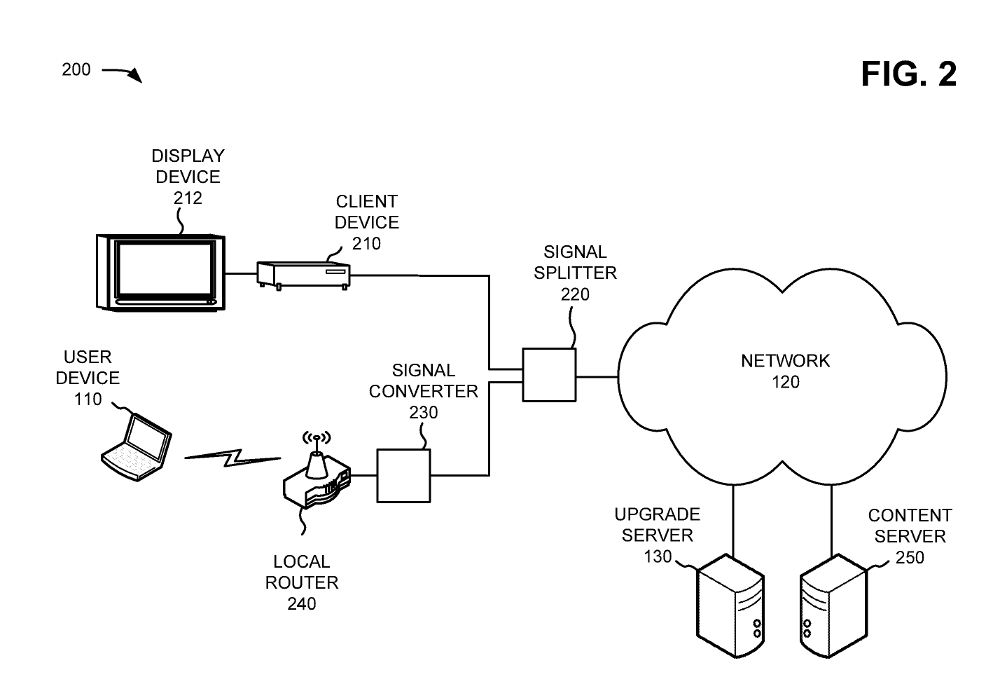

FIG. 2 is a diagram of an example environment 200 in which systems and/or methods, described herein, may be implemented. As illustrated, environment 200 may include user device 110, network 120, upgrade server 130, client device 210, display device 212, signal splitter 220, signal converter 230, local router 240, and content server 250. While FIG. 2 shows a particular number and arrangement of networks and devices, in alternative implementations, environment 200 may include additional networks or devices, fewer networks or devices, different networks or devices, or differently arranged networks or devices than those depicted in FIG. 2.

User device 110, network 120, and upgrade server 130 are discussed above with reference to FIG. 1. Client device 210 may include a device that receives and/or processes video content, and provides the video content to display device 212 or another device. Client device 210 may include a STB, a cable card, a computer, and/or another type of device. Client device 210 may also, or alternatively, include decoding and/or decryption capabilities, and may further include a digital video recorder (DVR) (e.g., a hard drive). In one implementation, client device 210 may conform to the multimedia over coax alliance (MoCA) standard, the single wire multi-switch (SWiM) standard, and/or one or more other types of networking standards or protocols.

Display device 212 may include a monitor capable of displaying video content, television programming, content provided by client device 210, and/or content provided by other devices (e.g., user device 110, a digital video disk (DVD) player, a video camera, etc.) connected to display device 112. In some implementations, one or more of the components or functionalities of client device 210 may be incorporated into display device 212.

Signal splitter 220 may include one or more splitting technologies to convey information between user device 110, client device 210, and network 120. In one implementation, signal splitter 220 may include a coaxial splitter that operates in accordance with the SWiM standard or one or more other types of network standards or protocols. For example, signal splitter 220 may facilitate allocating logical channels using different frequency blocks for viewer-selected television programming and broadband signals to SWiM-compatible client device 210 and/or local router 240. Signal converter 230 may include a device, such as a modem, to convert signals communicated between signal splitter 220 and local router 240.

Local router 240 may include a device that provides connectivity between user device 110 and network 120. In some implementations, local router 240 may include a wireless access point that employs one or more short-range wireless communication protocols for a WLAN, such as, for example, IEEE 802.15 (e.g., Bluetooth) and/or IEEE 802.11x (e.g., WiFi). In certain implementations, different short-range wireless protocols and/or frequencies may be used. Local router 240 may also include one or more wired (e.g., Ethernet) connections. In implementations where network 120 includes an LTE network, local router 240 may include a universal serial bus (USB) Ethernet Router that is capable of meeting LTE quality of service (QoS) standards.

As mentioned above, in some implementations, network 120 may include an optical fiber network (e.g., a fiber optic network). In such implementations, environment 200 may include an optical fiber network terminal (ONT), which may replace signal splitter 220 and/or signal converter 230. In such implementations, local router 240 may be repositioned to route information between the ONT, user device 110, and/or client device 210.

Content server 250 may include one or more of a variety of computing devices. For example, content server 250 may include a server, a cluster of servers, or one or more other types of computing or communication devices. In implementations where content server 250 includes multiple devices, the devices may be located in a single geographic location or multiple geographic locations. Content server 250 may be capable of storing media content (e.g., books, music, videos, etc.) and providing media content to user device 110.

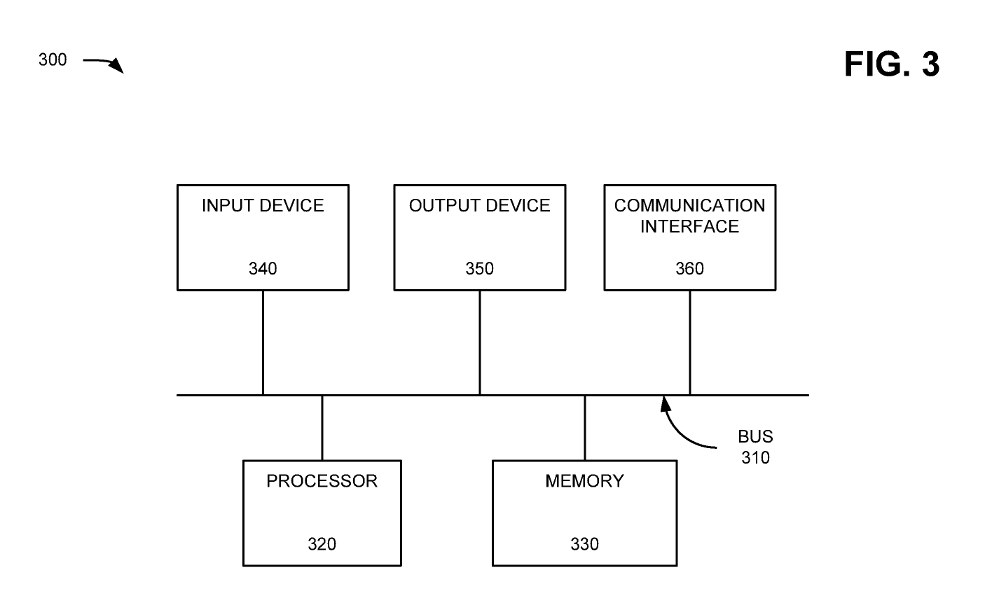

FIG. 3 is a diagram of example components of a device of FIG. 2. Device 300 may correspond to user device 110, upgrade server 130, client device 210, and/or content server 250. Each of user device 110, upgrade server 130, client device 210, and/or content server 250 may include one or more devices 300 or one or more of the components of device 300. As depicted in FIG. 3, device 300 may include bus 310, processor 320, memory 330, input device 340, output device 350, and communication interface 360. However, in other implementations, device 300 may include fewer components, additional components, different components, or differently arranged components than those illustrated in FIG. 3.

Bus 310 may include one or more component subsystems or communication paths that enable the components of device 300 to communicate. Processor 320 may include one or more processors, microprocessors, data processors, co-processors, network processors, application-specific integrated circuits (ASICs), controllers, programmable logic devices (PLDs), chipsets, field-programmable gate arrays (FPGAs), or other types of components that may interpret or execute instructions or data. Processor 320 may control the overall operation, or a portion thereof, of device 300, based on, for example, an operating system and/or various applications. Processor 320 may access instructions from memory 330, from other components of device 300, or from a source external to device 300 (e.g., a network or another device).

Memory 330 may include memory and/or secondary storage. For example, memory 330 may include random access memory (RAM), dynamic RAM (DRAM), read-only memory (ROM), programmable ROM (PROM), flash memory, or some other type of memory. Memory 330 may include a hard disk (e.g., a magnetic disk, an optical disk, a magneto-optic disk, a solid state disk, etc.) or some other type of computer-readable medium, along with a corresponding drive. A computer-readable medium may be defined as a non-transitory memory device. A memory device may include space within a single physical memory device or spread across multiple physical memory devices.

Input device 340 may include one or more components that permit a user to input information into device 300. For example, input device 340 may include a keypad, a button, a switch, a knob, fingerprint recognition logic, retinal scan logic, a web cam, voice recognition logic, a touchpad, an input port, a microphone, a display, or some other type of input component. Output device 350 may include one or more components that permit device 300 to output information to a user. For example, output device 350 may include a display, light-emitting diodes (LEDs), an output port, a speaker, or some other type of output component.

Communication interface 360 may include one or more components that permit device 300 to communicate with other devices or networks. For example, communication interface 360 may include some type of wireless or wired interface. Communication interface 330 may also include an antenna (or a set of antennas) that permit wireless communication, such as the transmission and reception of radio frequency (RF) signals.

As described herein, device 300 may perform certain operations in response to processor 320 executing software instructions contained in a computer-readable medium, such as memory 330. The software instructions may be read into memory 330 from another computer-readable medium or from another device via communication interface 360. The software instructions contained in memory 330 may cause processor 320 to perform one or more processes described herein. Alternatively, hardwired circuitry may be used in place of, or in combination with, software instructions to implement processes described herein. Thus, implementations described herein are not limited to any specific combination of hardware circuitry and software.

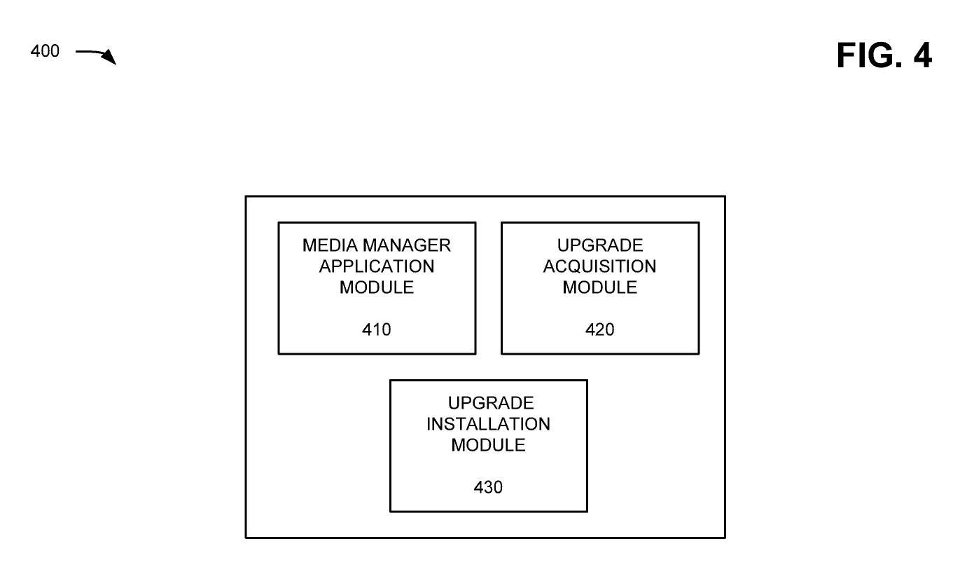

FIG. 4 is a diagram of example functional components of user device 110 according to one or more implementations described herein. As depicted, functional components 400 may include media manager application module 410, upgrade acquisition module 420, and upgrade installation module 430. Depending on the implementation, one or more of modules 410-430 may be implemented as a combination of hardware and software based on the components illustrated and described with respect to FIG. 3. Alternatively, modules 410-430 may each be implemented as hardware based on the components illustrated and described with respect to FIG. 3.

Media manager application module 410 may provide functionality with respect to operating a media manager application. For example, user device 110 may execute a media manager application. As mentioned above, a media manager application may enable a user of user device 110 to manage media files stored by user device 110 and/or browse, purchase, and/or download additional media files from content server 250. In some implementations, a media manager application may also, or alternatively, enable a user of user device 110 to stream one or more media files stored by user device 110 to other devices, including other user devices 110, client devices 210 (e.g., STBs), and/or one or more other types of electronic devices. In such implementations, the media files stored by user device 110 may be accessed via, for example, display device 212 and client device 210.

Upgrade acquisition module 420 may provide functionality with respect to obtaining media manager application upgrades. For example, user device 110 may detect that a media manager application upgrade is available by communicating with upgrade server 130. User device 110 may also, or alternatively, download media manager application upgrades from upgrade server 130. Additionally, or alternatively, user device 110 may cache the media manager application upgrade as temporary data. In certain implementations, at some point prior to the media manager application upgrade being installed, user device 110 may communicate with upgrade server 130 to verify that the media manager application upgrade is the most recent media manager application upgrade available.

Upgrade installation module 430 may provide functionality with respect to installing a media manager application upgrade. For example, user device 110 may notify a user device 110 that a media manager application upgrade is available. In some implementations, user device 110 may do so at some point after the media manager application upgrade has been cached. Additionally, or alternatively, user device 110 may install the media manager application upgrade in response to, for example, receiving a user input to install the media manager application upgrade. In some implementations, user device 110 may also, or alternatively, provide an installation interface to a user of user device 110 to enable the user to, for example, pause and resume the installation process.

In addition to the functionality described above, functional components 400 may also, or alternatively, provide functionality as described elsewhere in this specification. While FIG. 4 shows a particular number and arrangement of modules, in alternative implementations, functional components 410-430 may include additional modules, fewer modules, different modules, or differently arranged modules than those depicted.

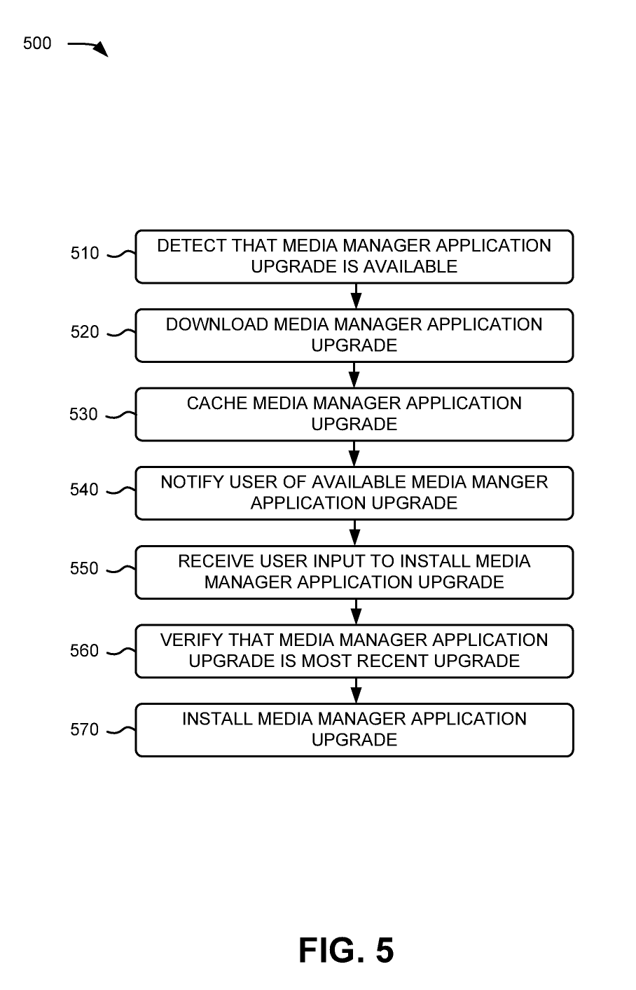

FIG. 5 is a diagram of an example process 500 for upgrading a media manager application according to one or more implementations described herein. In one or more implementations, process 500 may be performed by one or more components of user device 110. In other implementations, one or more blocks of process 500 may be performed by one or more other components/devices, or a group of components/devices, including or excluding user device 110.

An available media manager application upgrade may be detected (block 510). For example, user device 110 may detect that a media manager application upgrade is available by communicating with upgrade server 130. In some implementations, user device 110 may periodically send inquiries to upgrade server 130 regarding the availability of media manager application upgrades. In certain other implementations, user device 110 may receive notifications from upgrade server 130 regarding the availability of media manager application upgrades.

An available media manager application upgrade may be downloaded (block 520). For example, user device 110 may download a media manager application upgrade from upgrade server 130. In some implementations, the download may include a download (e.g., a background download) that does not prevent or otherwise disturb the execution of a media manager application corresponding to the media manager application upgrade. In some implementations, a media manager application upgrade may include one or more of a variety of data files including one or more catalog files (e.g., .CAT files) and/or compressed data files (e.g., .ZIP files, .RAR files, etc.).

A media manager application upgrade may be cached (block 530). For example, user device 110 may store a media manager application upgrade in a block of memory designated for temporarily storing data that is likely to be used in the near future. In some implementations, caching a media manager application upgrade may be performed at some point after the media manager application upgrade has been downloaded (block 520). Additionally, or alternatively, in implementations where the media manager application upgrade comprises one or more compressed data files, caching a media manager application upgrade may include decompressing or otherwise extracting the compressed data files.

A media manager application upgrade may be implemented as one or more data files that are compatible with an operating system of user device 110. In such implementations, downloading a media manager application upgrade may include downloading one or more data files to a temporary storage directory of user device 110. In some implementations, the data files may be cached at some point after the data files have been downloaded. In other implementations, the data files may be cached as the data files are downloaded.

A user may be notified of an available media manager application upgrade (block 540). For instance, user device 110 may notify a user that a media manager application upgrade is available for installation. In certain implementations, a user may be notified of an available media manager application upgrade at some point after the media manager application upgrade has been cached (block 530), which may provide for an expedited installation of the media manager application upgrade.

Notifying a user of a media manager application upgrade may include generating any number or combination of audio prompts (e.g., a bell, a chime, a honk, etc.), visual prompts (e.g., a graphical user interface (GUI) window with corresponding text), and/or one or more other types of prompts. In some implementations, notifying a user that a media manager application upgrade is available may include prompting the user to indicate whether the media manager application upgrade should be installed.

A user input to install a media manager application upgrade may be received (block 550). For example, user device 110 may receive an install command from the user of user device 110. In some implementations, the install command may be received at some point after the user has been notified of an available media manager application upgrade (block 540).

A media manager application upgrade may be verified as the most recent media manager application upgrade (block 560). For instance, user device 110 may communicate with upgrade server 130 to verify whether a particular media manager application upgrade is the most recent media manager application upgrade (e.g., the latest version of a media manager application). In some implementations, this may be performed at some point after a user input is received to install a media manager application upgrade (block 550). However, in certain implementations, this may also, or alternatively, be performed at some point prior to notifying a user that a media manager application upgrade is available (block 540).

In some implementations, if user device 110 is able to verify that, for example, a cached media manager application upgrade is the most recent media manager application upgrade, user device 110 may, at some point, install the cached media manager application upgrade (block 570). However, if, in attempting to verify that a cached media manager application upgrade is the most recent, user device 110 determines that a more recent media manager application upgrade is available, user device 110 may download and cache the more recent media manager application upgrade from upgrade server 130 prior to installing the new media manager application upgrade (block 570).

As mentioned above, a media manager application upgrade may be installed (block 570). For instance, user device 110 may install a media manager application upgrade. In certain implementations, user device 110 may install the entire media manager application upgrade without requiring any input from a user. For example, user device 110 may install the media manager application upgrade without requiring the user to agree to an end-user license agreement (EULA), specify a location for installing the media manager application upgrade, and/or requiring one or more other types of user inputs. In some implementations, this may be facilitated by a catalog file (e.g., .CAT file) of the media manager application upgrade. Additionally, or alternatively, user device 110 may install a media manager application upgrade at some point after the media manager application upgrade has already been downloaded and/or cached to memory.

While FIG. 5 shows a flowchart diagram of an example process 500 for upgrading a media manager application, in other implementations, a process for upgrading a media manager application may include fewer operations, different operations, differently arranged operations, or additional operations than depicted in FIG. 5.

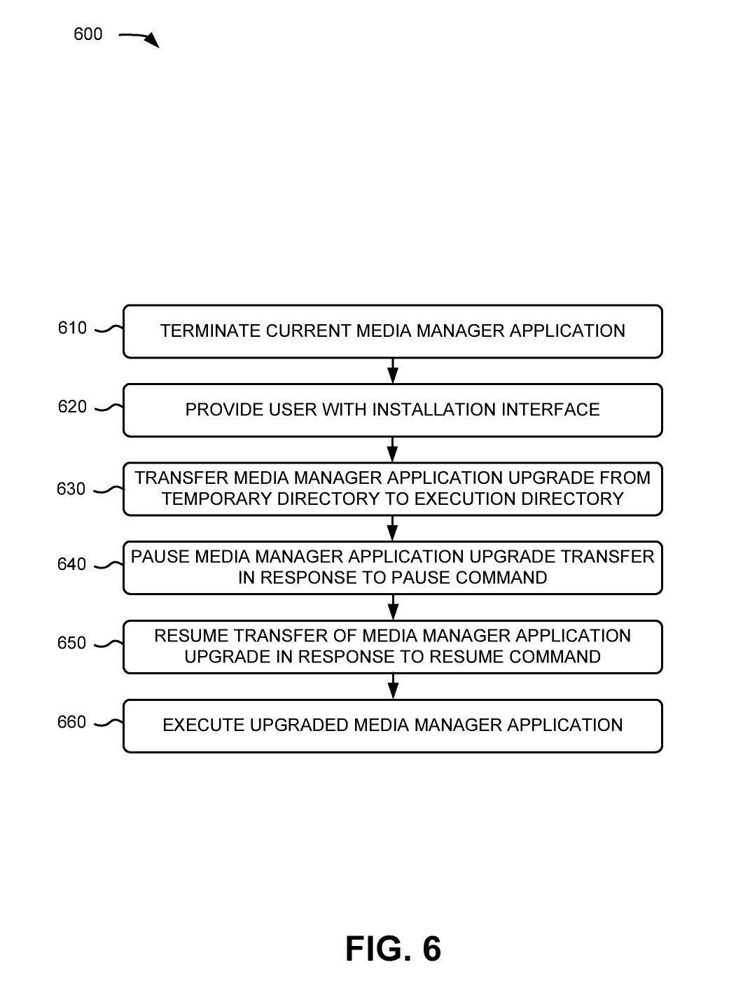

FIG. 6 is a diagram of an example process 600 for installing a media manager application upgrade according to one or more implementations described herein. In one or more implementations, process 600 may be performed by one or more components of user device 110. In other implementations, one or more blocks of process 600 may be performed by one or more other components/devices, or a group of components/devices, including or excluding user device 110.

A current media manager application may be terminated (block 610). For example, user device 110 may terminate a media manager application that is currently being executed by user device 110. In some implementations, this may be performed in scenarios where a media manager application is currently running or otherwise being executed by user device 110 and an install command, corresponding to a media manager application upgrade, is received (see, for example, FIG. 5, block 550).

An installation interface may be provided to a user (block 620). For instance, user device 110 may generate a GUI corresponding to an installation of a media manager application upgrade. In some implementations, an installation interface may include one or more interface objects (e.g., buttons) for controlling the installation of the media manager application upgrade. For example, an installation interface may include a pause button for pausing the installation of the media manager application upgrade and/or a resume button for resuming the installation of the media manager application upgrade. Additionally, or alternatively, an installation interface may include a progress bar or one or more other types of visual or textual representations of the installation of a media manager application upgrade.

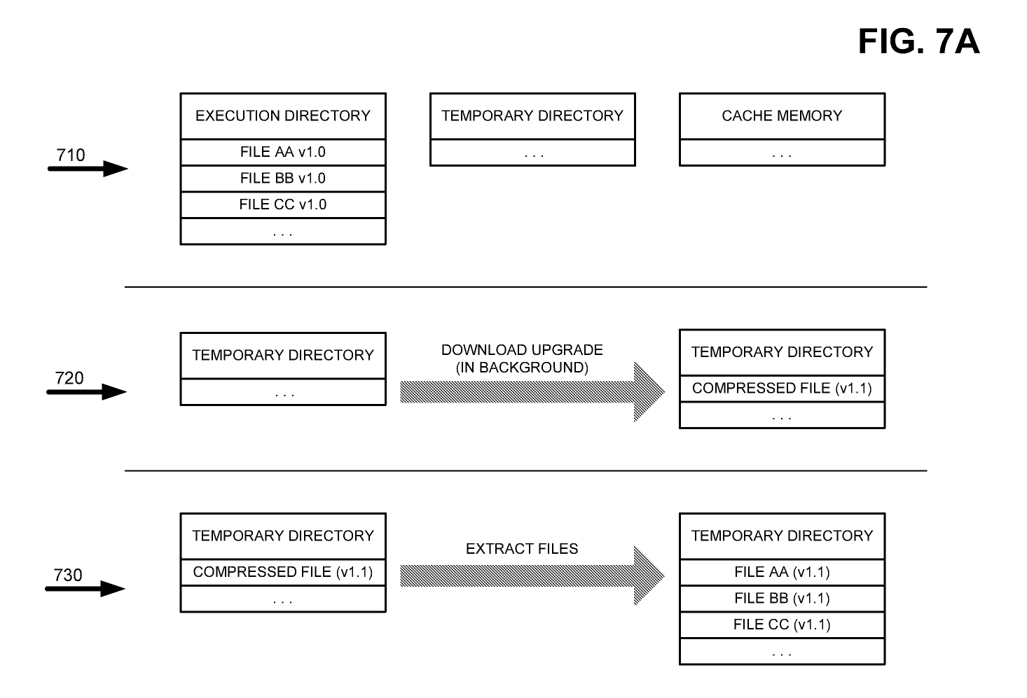

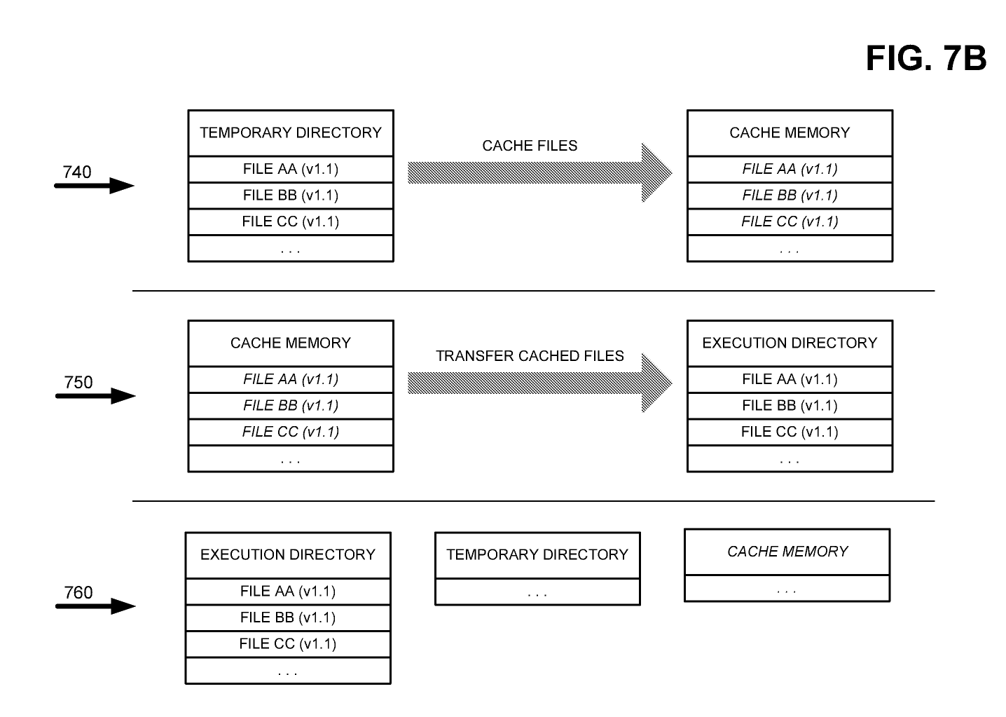

A media manager application upgrade may be transferred from a temporary directory to an execution directory (block 630). For example, user device 110 may transfer data files, corresponding to a media manager application upgrade, from a directory designated for temporary files (e.g., a temporary directory) to a directory designated for a media manager application (e.g., an execution directory). In some implementations, transferring data files from a temporary directory to an execution directory may include replacing or otherwise updating one or more data files currently located in the execution directory. Execution directories and temporary directories are described in more detail below with reference to FIGS. 7A-7B.

A media manager application upgrade transfer may be paused (block 640). For example, user device 110 may pause a transfer of a media manager application upgrade from a temporary directory to an execution directory. In some implementations, user device 110 may pause a media manager application upgrade transfer in response to receiving a pause command. In certain implementations, user device 110 may receive the pause command from a user via an installation interface.

A media manager application upgrade transfer may be resumed (block 650). For instance, user device 110 may resume a transfer of a media manager application upgrade from a temporary directory to an execution directory. Similar to the pause command mentioned above, user device 110 may resume a media manager application upgrade transfer in response to receiving a resume command, which may be received from a user via an installation interface.

An upgraded media manager application may be executed (block 660). For example, user device 110 may execute a media manager application at some point after a media manager application upgrade has been transferred from a temporary directory to an execution directory. In some implementations, this may be performed in scenarios where the execution of a media manager application was terminated by user device 110 (see, for example, block 610).

While FIG. 6 shows a flowchart diagram of an example process 600 for installing a media manager application upgrade, in other implementations, a process for installing a media manager application upgrade may include fewer operations, different operations, differently arranged operations, or additional operations than depicted in FIG. 6.

FIGS. 7A-7B are diagrams of example data structures 710-760 according to one or more implementations described herein. In one or more implementations, data structures 710-760 may correspond to one or more components of user device 110. In other implementations, one or more of data structures 710-760 may correspond to one or more other components/devices, or a group of components/devices, including or excluding user device 110.

Referring to data structures 710 of FIG. 7A, user device 110 may include an execution directory, a temporary directory, and a cache memory. An execution directory may include a file directory selected or otherwise designated for storing one or more data files (e.g., program files, executable files, configuration files, directory files, etc.) defining or otherwise corresponding to the operation and/or structure of a media manager application. A temporary directory may include a file directory selected or otherwise designated for temporarily storing one or more data files for upgrading a media manager application. A cache memory may include one or more blocks of memory selected or otherwise designated for temporarily storing data in a manner that, for example, may enable requests for the data to be served faster than serving the requests via main memory.

As depicted by data structures 710 of FIG. 7A, the execution directory may include multiple data files (e.g., FILE AA, FILE BB, FILE CC, etc.) corresponding to a media manager application that is currently installed on user device 110. As depicted, the data files in the execution directory may correspond to a particular version (e.g., v1.0) of the media manager application. The temporary directory and/or the cache memory may be empty. In some implementations, data structures 710 may correspond to a scenario where user device 110 includes version 1.0 of a media management application and may, at some point, detect that a media management application upgrade is available (see, for example, FIG. 5, block 510).

Referring to data structures 720, user device 110 may download a media management application upgrade and store the media management application upgrade in the temporary directory (see, for example, FIG. 5, block 520). In the depicted example corresponding to data structures 720, the media management application upgrade may be downloaded as one or more compressed files corresponding to a more recent version (e.g., v1.1) of the media management application than the files stored in the execution directory (e.g., v1.0).

Referring to data structures 730, individual data files may be extracted from the compressed file and stored in the temporary directory. As illustrated, the extracted data files may be similar to the data files in the execution directory. However, similar to the compressed file, the extracted data files in the temporary directory may correspond to a more recent version of the media management application than the data files in the execution directory.

Referring to data structures 740 of FIG. 7B, the extracted data files in the temporary directory may be cached to the cache memory (see, for example, FIG. 5, block 530). Referring to data structures 750, the cached data files in the cache memory may be transferred to the execution directory (see, for example, FIG. 6, block 630). Transferring the cached data files to the execution directory may include updating and/or replacing one or more files in the execution directory. For example, referring to data structures 760, transferring the cached data files may replace the version 1.0 data files with the version 1.1 data files. Additionally, transferring the cached data files may clear the temporary directory and the cache memory, similar to data structures 710 described above.

As set forth above, devices may be used to expeditiously upgrade a media manager application with minimal user interaction. For example, user device 110 may execute a media manager application for managing media files stored by user device 110. User device 110 may detect that a media manager application upgrade is available and download the media manager application upgrade using a background download operation that does not prevent user device 110 from executing the currently installed media manager application. User device 110 may cache the media manager application upgrade as temporary data and notify a user of user device 110 that the media manager application upgrade is ready for installation. User device 110 may receive an install command, corresponding to the media manager application upgrade, from the user and install the media manager application upgrade in response to the install command.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Further, certain implementations may involve a component that performs one or more functions. These components may include hardware, such as an ASIC or a FPGA, or a combination of hardware and software.

Even though particular combinations of features are recited in the claims and/or disclosed in the specification, these combinations are not intended to limit disclosure of the possible implementations. In fact, many of these features may be combined in ways not specifically recited in the claims and/or disclosed in the specification. Although each dependent claim listed below may directly depend on only one other claim, the disclosure of the implementations includes each dependent claim in combination with every other claim in the claim set.

No element, act, or instruction used in the present application should be construed as critical or essential to the implementations unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, comprising:
executing, by a device, a media manager application comprising a software application for managing media content stored by the device;
downloading, by the device, a media manager application upgrade, where downloading the media manager application upgrade comprises performing a background download operation independent from execution of the media manager application;
caching, by the device, the media manager application upgrade as temporary data;
notifying, by the device, a user of the device that the media manager application upgrade is ready for installation in response to caching the media manager application upgrade;
receiving, by the device, an install command, corresponding to the media manager application upgrade, from the user; and
installing the media manager application upgrade in response to the install command.

2. The method of claim 1, further comprising:
prior to downloading the media manager application upgrade,
periodically communicating with an upgrade server; and
detecting that the media manager application upgrade is available from the upgrade server based on the periodic communication with the upgrade server.

3. The method of claim 1, where:
the media manager application upgrade comprises at least one software file that is compatible with an operating system of the device, and
caching the media manager application upgrade comprises storing the at least one software file in a temporary directory of the operating system of the device.

4. The method of claim 1, further comprising:
verifying that a more recent media manager application upgrade is not available in response to receiving the install command.

5. The method of claim 1, where installing the media manager application upgrade comprises upgrading the media manager application, in accordance with the media manager application upgrade, without requiring input from the user.

6. The method of claim 1, where:
the media manager application comprises data stored in an execution directory of an operating system of the device,
caching the media manager application upgrade comprises storing the media manager application upgrade in a temporary directory of the operating system, and
installing the media manager upgrade comprises transferring the media manager application upgrade from the temporary directory to the execution directory.

7. The method of claim 6, where the media manager application upgrade comprises a compressed data file, and the method further comprises:
extracting data files from the compressed data file prior to caching the media manager application upgrade.

8. The method of claim 1, further comprising:
terminating the media manager application, prior to installing the media manager application upgrade.

9. The method of claim 1, where installing the media manager application upgrade comprises:
providing the user with an installation interface to enable the user to pause or resume an installation of the media manager application upgrade,
pausing the installation of the media manager application upgrade in response to receiving a pause command from the user via the installation interface, and
resuming the installation of the media manager application upgrade in response to receiving a resume command from the user via the installation interface.

10. The method of claim 1, where:
the device comprises a user device corresponding to a local area network (LAN),
the media manager application is for streaming media content from the device to other devices, and
the other devices comprise a set-top-box (STB) corresponding to the LAN.

11. A user device, comprising:
a memory to store instructions; and
a processor, connected to the memory, to:
execute a media manager application comprising a software program for streaming media content from the user device to a set-top-box (STB);
download a media manager application upgrade in a manner that is independent from the execution of the media manager application;
cache the media manager application upgrade to a cache memory of the user device;
notify a user of the user device that the media manager application upgrade is ready for installation in response to caching the media manager application upgrade;
receive an install command, corresponding to the media manager application upgrade, from the user; and
install the media manager application upgrade in response to the install command.

12. The user device of claim 11, where the processor is to:
periodically communicate with an upgrade server,
detect that the media manager application upgrade is available from the upgrade server based on the periodic communication with the upgrade server, and
download the media manager application upgrade from the upgrade server when the media manager application upgrade is available.

13. The user device of claim 11, where:
the media manager application upgrade comprises at least one software file that is compatible with an operating system of the device, and
to cache the media manager application upgrade, the processor is to:
store the at least one software file in a temporary directory of the operating system of the device.

14. The user device of claim 11, where the processor is to:
prior to installing the media manager application upgrade,
identify a version associated with the media manager application upgrade,
communicate with an upgrade server to determine whether a more recent media manager application upgrade is available,
when a more recent media manager application upgrade is not available,
install the media manager application upgrade, and
when a more recent media manager application upgrade is available,
notify the user of the more recent media manager application upgrade,
download the more recent media manager application upgrade, and
install the more recent media manager application upgrade.

15. The user device of claim 11, where, to install the media manager application upgrade, the processor is to:
upgrade the media manager application, in accordance with the media manager application upgrade, without requiring an input from the user.

16. The user device of claim 11, where:
the media manager application comprises data stored in an execution directory of an operating system of the device,
to cache the media manager application upgrade, the processor is to store the media manager application upgrade in a temporary directory of the operating system, and
to install the media manager application upgrade, the processor is to transfer the media manager application upgrade from the temporary directory to the execution directory.

17. The user device of claim 16, where:
the media manager application upgrade comprises a compressed data file, and
to install the media manager application upgrade, the processor is to decompress the compressed data file prior to the transfer of the media manager application upgrade to the execution directory.

18. The user device of claim 11, where the processor is to:
terminate the media manager application prior to the installation of the media manager application upgrade.

19. The user device of claim 11, where, to install the media manager application upgrade, the processor is to:
provide the user with an installation interface to enable the user to pause or resume the installation of the media manager application upgrade,
pause the installation of the media manager application upgrade in response to receiving a pause command from the user via the installation interface, and
resume the installation of the media manager application upgrade in response to receiving a resume command from the user via the installation interface.

20. A non-transitory computer-readable medium storing a program for causing a device to perform a method, the method comprising:
executing a first media manager application that comprises a software application for streaming media content from the device to other devices, where the media manager application is stored as data files in an execution directory of an operating system of the device;
downloading a second media manager application comprising a more recent version of the first media manager application, where downloading the second media manager application comprises a background download operation independent from the execution of the first media manager application;
caching the second media manager application as data files in a temporary directory of the operating system;
notifying a user of the device that the second media manager application is ready for installation in response to caching the second media manager application;
receiving an install command, corresponding to the second media manager application, from the user; and
updating the data files, associated with the first media manager application, with the data files associated with the second media manager application.

21. The computer-readable medium of claim 20, where updating the data files associated with the first media manager application comprises replacing at least one of the data files, associated with the first media manager application, with at least one of the data files associated with the second media manager application.

22. The computer-readable medium of claim 20, the method further comprising:
terminating a process corresponding to executing the first media manager application prior to updating the data files, associated with the first media manager application, with the data files associated with the second media manager application.
